(19) United States
(12) Patent Application Publication
(10) Pub. No.: US 2021/0284383 A1
(43) Pub. Date: Sep. 16, 2021

(54) RETAIL READY HARNESS STYLE WRAP AROUND CASE

(71) Applicant: WestRock Shared Services, LLC, Atlanta, GA (US)

(72) Inventor: Pinocchio Zore Cline, Conyers, GA (US)

(21) Appl. No.: 16/818,466

(22) Filed: Mar. 13, 2020

(51) Int. Cl. B65D 5/54; B31B 50/26

(52) U.S. Cl. CPC B65D 5/5445; B31B 50/26

(57) ABSTRACT

A blank for constructing the retail ready package includes a lower front panel having a central panel separably connected to a remainder of the lower front panel between front lines of weakness. A bottom panel is foldably connected to the lower front panel along a lower front horizontal fold line. A rear panel is foldably connected to at least one of the left or right bottom panels along a lower rear horizontal fold line. A top panel is connected to the rear panel along an upper rear horizontal line of weakness and/or an upper rear fold line. An upper front panel is foldably connected to the top panel along an upper front horizontal fold line.

### BACKGROUND OF THE INVENTION

### 1. Field of the Invention

The subject invention is directed to product packaging, and more particularly, to a retail ready harness style wrap around case configured to display products.

### 2. Description of Related Art

Retailers, such as big-box stores, superstores and warehouse clubs sell large quantities of fast moving consumer goods. These retailers often want to have items shipped from their distribution centers to stores in unit loads and bulk boxes that can be stocked without handling of the merchandise. The goal for corrugated shipping containers is to put case goods directly onto shelves and stocking locations without individually handling the unit packs or primary packages. To this end, retailers often require products to come in shelf ready packaging to reduce stocking costs and save labor expenses. Shelf ready packaging, also known as, retail ready packaging refers to the packaging of a product so that it is delivered to a retailer in a manner optimized for efficient stocking and sale.

Some retailers prefer to ship carded products, such as blister packs and frozen foods, in two separate rows arranged in a side-by-side orientation. However, this orientation presents problems when displaying the products on a shelf so that they are aesthetically pleasing and readily accessible to a customer. Thus, it would be beneficial to provide a retail ready package that is adapted and configured for displaying two separate rows of products that are arranged side-by-side in a vertical front facing display orientation for ready access by a consumer. The subject invention provides for such a package.

### SUMMARY OF THE DISCLOSURE

The subject invention is directed to a retail ready package configured for division into two separate product display cases wherein two rows of products are arranged side-by-side within the package in a vertical front facing display orientation relative to the left and right lower front panels of the package.

A blank for constructing the retail ready package includes a lower front panel having a central panel separably connected to a remainder of the lower front panel between front lines of weakness. A bottom panel is foldably connected to the lower front panel along a lower front horizontal fold line. A rear panel is foldably connected to at least one of the left or right bottom panels along a lower rear horizontal fold line. A top panel is connected to the rear panel along an upper rear horizontal line of weakness and/or an upper rear fold line. An upper front panel is foldably connected to the top panel along an upper front horizontal fold line.

In some embodiments, the rear panel includes an upper rear panel. The rear panel can include left and right lower rear panels separated from one another along a rear vertical line of weakness. The bottom panel can include left and right bottom panels that are foldably connected to the lower front panel along a lower front horizontal fold line and separated from one another along a bottom vertical line of weakness. The top panel can be foldably connected to the upper rear panel along the upper rear fold line. The central panel, the top panel, the upper front panel and the upper rear panel can be adapted and configured to be separated from the remainder of the lower front panel, the bottom panel and the left and right lower rear panels along a rear horizontal line of weakness and the front lines of weakness. The remainder of the lower front panel can include a left lower front panel and a right lower front panel. The left lower front panel, the left bottom panel and the left lower rear panel can be adapted and configured to be divided from the right lower front panel, the right bottom panel and the right lower rear panel along the bottom vertical line of weakness and the rear vertical line of weakness to form two separate product display cases. The rear horizontal line of weakness can be a continuous linear line of weakness. The rear horizontal line of weakness can be a perforation line.

In some embodiments, the rear panel includes left and right rear panels separated from one another along a rear vertical line of weakness. The central panel, the top panel and the upper front panel can be adapted and configured to be separated from the remainder of the lower front panel, the bottom panel and the rear panel along the upper rear horizontal line of weakness and the front lines of weakness. The remainder of the lower front panel can include a left lower front panel and a right lower front panel. The left lower front panel, the left bottom panel and the left rear panel can be adapted and configured to be divided from the right lower front panel, the right bottom panel and the right rear panel along the bottom vertical line of weakness and the rear vertical line of weakness to form two separate product display cases.

The front lines of weakness can be at a non-zero angle relative to the lower front horizontal fold line. The lower front horizontal fold line can include a cut portion that defines a bottom edge of the central panel. An aperture can be defined in the bottom panel, e.g. across the left and right bottom panels. An edge of the aperture can be defined by a bottom edge of the central panel. The left and right rear panels can have respective left and right rear side flaps foldably connected thereto. The upper rear horizontal line of weakness can be a continuous linear line of weakness. The upper rear horizontal line of weakness can be a perforation line.

In accordance with another aspect, a retail ready package configured for division into two separate product display cases includes a lower front panel having a central panel separably connected to a remainder of the lower front panel between front lines of weakness. A bottom panel is foldably connected to the lower front panel along a lower front horizontal fold line. A rear panel is foldably connected to the bottom panel along a lower rear horizontal fold line. A top panel is connected to the rear panel along at least one of an upper rear horizontal line of weakness or an upper rear fold line. An upper front panel is foldably connected to the top panel along an upper front horizontal fold line.

In some embodiments, the rear panel includes an upper rear panel, and a lower rear panel. Lower rear panel can include left and right lower rear panels separated from one another along a rear vertical line of weakness, similar to the blank described above. The bottom panel can include left and right bottom panels that are foldably connected to the lower front panel along a lower front horizontal fold line and separated from one another along a bottom vertical line of weakness. The top panel can be foldably connected to the upper rear panel along the upper rear fold line. The central panel, the top panel, the upper front panel and the upper rear panel can be adapted and configured to be separated from the remainder of the lower front panel, the bottom panel and the lower rear panel along a rear horizontal line of weakness and the front lines of weakness. The remainder of the lower front panel can include a left lower front panel and a right lower front panel. The left lower front panel, the left bottom panel and the left lower rear panel can be adapted and configured to be divided from the right lower front panel, the right bottom panel and the right lower rear panel along the bottom vertical line of weakness and the rear vertical line of weakness to form two separate product display cases. The rear horizontal line of weakness can be a continuous linear line of weakness. The rear horizontal line of weakness can be a perforation line.

In some embodiments, the rear panel includes left and right rear panels separated from one another along a rear vertical line of weakness. The central panel, the top panel and the upper front panel can be adapted and configured to be separated in a similar manner as that described above with respect to the blank. The remainder of the lower front panel can include a left lower front panel and a right lower front panel. The left lower front panel, the left bottom panel and the left rear panel can be adapted and configured to be divided in a similar manner to that described above with respect to the blank.

The front lines of weakness and the lower front horizontal fold line are similar to those described above. An aperture can be defined in the bottom panel, e.g. across the left and right bottom panels and is similar to that described above. The upper rear horizontal line of weakness can be similar to that described above. Two rows of products are arranged side-by-side within the package in a vertical front facing display orientation relative to the lower front panel of the package. An outer surface of the central panel can be adhered to an inner surface of the upper front panel.

These and other features of the retail ready package of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those skilled in the art will readily understand how to make and use the retail ready package of the subject invention without undue experimentation, preferred embodiments thereof will be described in detail herein below with reference to the figures wherein:

FIG. 1 is a schematic top plan view of an embodiment of a blank for forming a retail ready package in accordance with the present disclosure, showing a removable portion and a display portion;

FIG. 2 is a schematic perspective view of the retail ready package formed by the blank of FIG. 1, showing the upper rear horizontal line of weakness that separates the top panel and the left and right rear panels;

FIG. 3 is a schematic perspective view of the retail ready package formed by the blank of FIG. 1, showing the removable portion of the package completely separated from the display portion of the package;

FIG. 4 is a schematic perspective view of the retail ready package formed by the blank of FIG. 1, showing the display portion of the package divided into two separate product display cases;

FIG. 5 is a schematic top plan view of another embodiment of a blank for forming a retail ready package in accordance with the present disclosure, showing a removable portion and a display portion;

FIG. 6 is a schematic perspective view of the retail ready package formed by the blank of FIG. 5, showing the front and top panels;

FIG. 7 is a schematic perspective view of the retail ready package formed by the blank of FIG. 5, showing the removable portion of the package completely separated from the display portion of the package;

FIG. 8 is a schematic perspective view of the retail ready package formed by the blank of FIG. 5, showing the display portion of the package divided into two separate product display cases;

FIG. 9 is a schematic top plan view of another embodiment of a blank for forming a retail ready package in accordance with the present disclosure, showing a removable portion and a display portion;

FIG. 10 is a schematic perspective view of the retail ready package formed by the blank of FIG. 9, showing the upper rear horizontal line of weakness that separates the top panel and the left and right rear panels;

FIG. 11 is a schematic perspective view of the retail ready package formed by the blank of FIG. 9, showing the removable portion of the package completely separated from the display portion of the package;

FIG. 12 is a schematic perspective view of the retail ready package formed by the blank of FIG. 9, showing the display portion of the package divided into two separate product display cases; and

FIG. 13 is a schematic top plan view of another embodiment of a blank for forming a retail ready package in accordance with the present disclosure, showing a removable portion and a display portion.

### DETAILED DESCRIPTION OF THE PREFERRED EMBODIMENTS

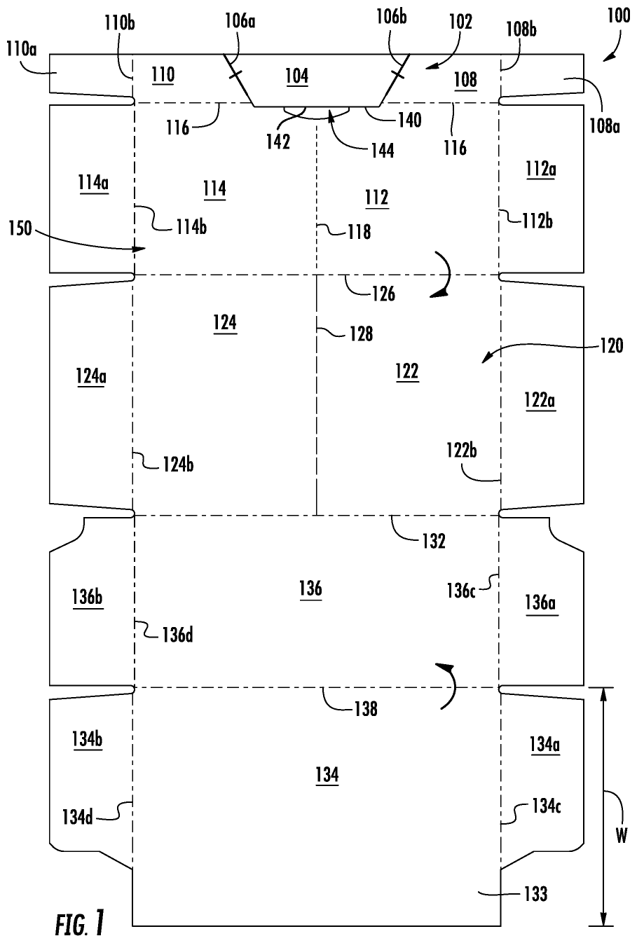

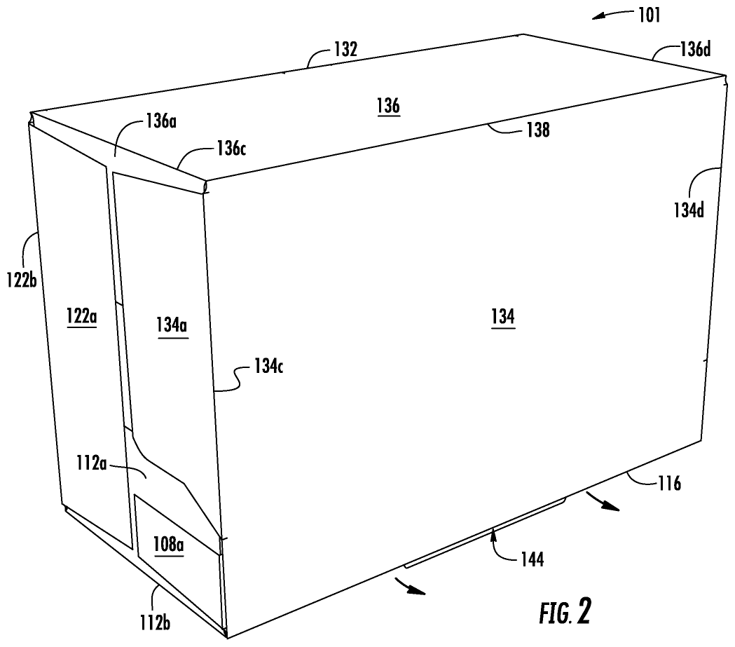

Reference will now be made to the drawings wherein like reference numerals identify similar structural features or aspects of the subject disclosure. For purposes of explanation and illustration, and not limitation, a perspective view of an embodiment of a blank for a retail ready package 101 in accordance with the disclosure is shown in FIG. 1 and is designated generally by reference character 100. Retail ready package 101 is for shipping and displaying products, and more particularly, a harness wrap style retail ready package configured for division into two separate product display cases 103a and 103b Other embodiments of blanks and/or packages in accordance with the disclosure, or aspects thereof, are provided in FIGS. 2-13, as will be described.

As shown in FIGS. 1-4, the blank 100 for constructing the retail ready package 101 is configured for division into two separate product display cases 103a and 103b. The blank 100 is formed from a die cut corrugated cardboard sheet. The blank 100 includes a lower front panel 102 having a central panel 104 separably connected to a remainder of the lower front panel between front lines of weakness 106a and 106b. Central panel 104 provides stability to the front panel 102 and package 101 during packing and shipping, but is then removed when lines of weakness 106a and 106b are severed. This allows the package 101 to be split into two separate cases 103a and 103b for display. The remainder of the lower front panel includes left and right lower front panels 108 and 110. The left and right lower front panels 108 and 110 have respective left and right lower front side flaps 108a and 110a that are foldably connected thereto along respective fold lines 108b and 110b.

As shown in FIG. 1, a bottom panel 150 includes left and right bottom panels 112 and 114 are respectively foldably connected to the left and right lower front panels 108 and 110 along a lower front horizontal fold line 116 and they are separated from one another along a bottom vertical line of weakness 118, e.g. break lines, cut lines, perforation lines, any combination thereof, or the like. The lower front horizontal fold line 116 includes a cut portion 140, shown by the solid line between the two broken lines, that defines a bottom edge 142 of the central panel 104. An aperture 144 is defined across the left and right bottom panels 112 and 114. An edge of the aperture 144 is defined by the bottom edge 142 of the central panel. The aperture 144 aligns with the central panel 104 that separates the left and right lower front panels 108 and 110 from one another. The aperture 144 is an opening where the central panel 104 and an upper front panel 134 can be grasped by a user to facilitate the severing of lines of weakness 106a, 106b and 132, thereby also facilitating separation of the removable portion of the package 101 (e.g. the central panel 104, the upper rear panel 121 the upper front panel 134 and associated flaps, and the top panel 136 and associated flaps) from the display portion 101′ of the package 101, shown schematically by arrows in FIG. 2.

With continued reference to FIG. 1, the front lines of weakness 106a and 106b are at a non-zero angle relative to the lower front horizontal fold line 116. The left and right bottom panels 112 and 114 have respective left and right bottom side flaps 112a and 114a foldably connected thereto along respective vertical fold lines 112b and 114b. The rear panel 120 includes left and right rear panels 122 and 124 respectively foldably connected to the left and right bottom panels 112 and 114 along a lower rear horizontal fold line 126. Left and right rear panels 122 and 124 are separated from one another along a rear vertical line of weakness 128, e.g. break lines, cut lines, perforation lines, any combination thereof, or the like. The left and right rear panels 122 and 124 have respective left and right rear side flaps 122a and 124a foldably connected thereto along respective vertical fold lines 122b and 124b.

As shown in FIG. 1, the blank 100 also includes a top panel 136 that is separably connected to the left and right rear panels 122 and 124 along an upper rear horizontal line of weakness 132. Upper front panel 134 is foldably connected to the top panel 136 along an upper front horizontal fold line 138. The upper rear horizontal line of weakness 132 is a continuous linear, e.g. straight, line of weakness that is a perforation line, or the like. The upper rear horizontal line of weakness is substantially parallel to the other horizontal fold lines of blank 100, e.g. fold lines 126 and 138, and substantially perpendicular to rear vertical perforation line 128. The lines of weaknesses or other perforation lines can be formed by a PERFormaX 860 steel rule (available from National Steel Rule, Linden, N.J.), or the like.

With continued reference to FIG. 1, the top panel 136 has left and right top side flaps 136a and 136b foldably connected thereto along respective fold lines 136c and 136d. The upper front panel 134 has left and right upper front side flaps 134a and 134b foldably connected thereto along respective fold lines 134c and 134d. The left and right upper front side flaps 134a and 134b are formed along a portion of the width W of the upper front panel to facilitate hand hold areas for carrying the fully erected and loaded retail ready package 101 of the subject invention. The central panel 104, the top panel 136 and the upper front panel 134 are adapted and configured to be separated from the remainder of the lower front panel, e.g. left and right lower front panels 108 and 110, the left and right bottom panels 112 and 114 and the left and right rear panels 122 and 124 along the upper rear horizontal line of weakness 132 and the front lines of weakness 106a and 106b.

Referring now to FIGS. 1-3, to erect the retail ready package 101 of the subject invention from the die cut blank 100, the left and right bottom panels 112 and 114 are folded relative to the left and right rear panels 122 and 124 along the lower rear horizontal fold line 126, and the upper front panel 134 is folded relative to the top panel 136 along the upper front horizontal fold line 138, shown schematically by arrows in FIG. 1. At such a time, two rows of products can be loaded into the partially erected package 101 in side-by-side relationship. Thereafter, to fully erect the retail ready package 101 for shipping, the top panel 136 is folded relative to the left and right rear panels 122 and 124 along the upper rear horizontal line of weakness 132, and left and right lower front panels 108 and 110 are folded relative to the left and right bottom panels 112 and 114 along the lower front horizontal fold line 116.

An outer surface of the central panel 104 is adhered to an inner surface 133 of the upper front panel 134. Then, the side flaps of each of the panels are folded into place and glued, so as to fully form the package 101, as shown in FIG. 2. More particularly, side flaps 136a, 136b, 112a and 114a form interior side flaps of the package, while side flaps 122a, 124a, 134a, 134b, 108a and 108b form exterior side flaps of the package 101. It is contemplated that no glue is present between side flap 136a and side flap 122a, nor between side flap 134a and 112a, such that top panel 136 and upper front panel 134 are free to be separated from bottom and rear panels 112 and 114 and 122 and 124, respectively. Those skilled in the art will readily appreciate that the packing and shipping orientation can be different from the display orientation shown in FIGS. 2-4. For example, package 101 may be packed and shipped with the rear panel 120 on the bottom with respect to gravity and the upper front panel 134 facing upwards, the same can be said for packages 201 and 301, described below.

As shown in FIGS. 2-4, to prepare the retail ready package 101 of the subject invention for display, whereby the removable portion of the package 101 is separated from the display portion 101′ of the package 101, the package 101 should be in its display orientation with rows of products 130a and 130b facing forward. Rows of products 130a and 130b are shown schematically in dashed lines for sake of clarity. Then, the top panel 136, the upper front panel 134, the central panel 104, and the side flaps associated therewith are separated from the left and right lower front panels 108 and 110, the left and right bottom panels 112 and 114, and the left and right rear panels 122 and 124 along the upper rear horizontal line of weakness 132 and front lines of weakness 106a and 106b.

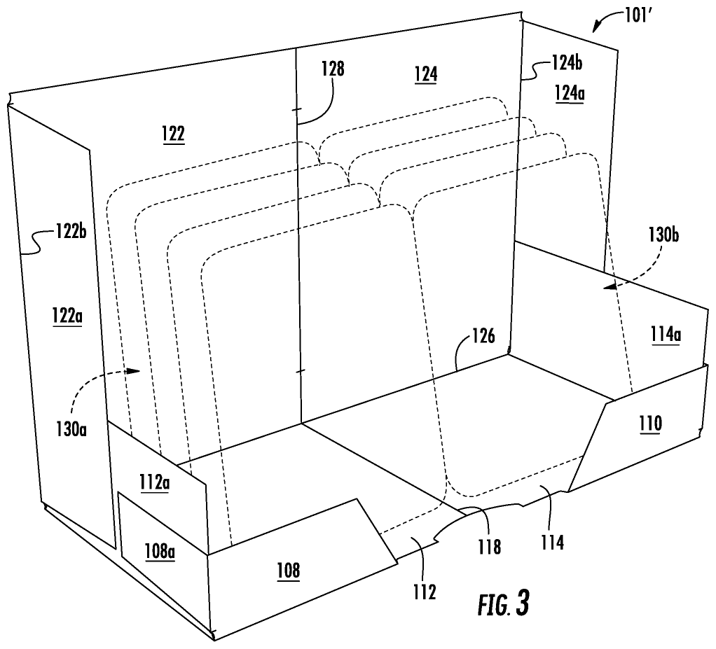

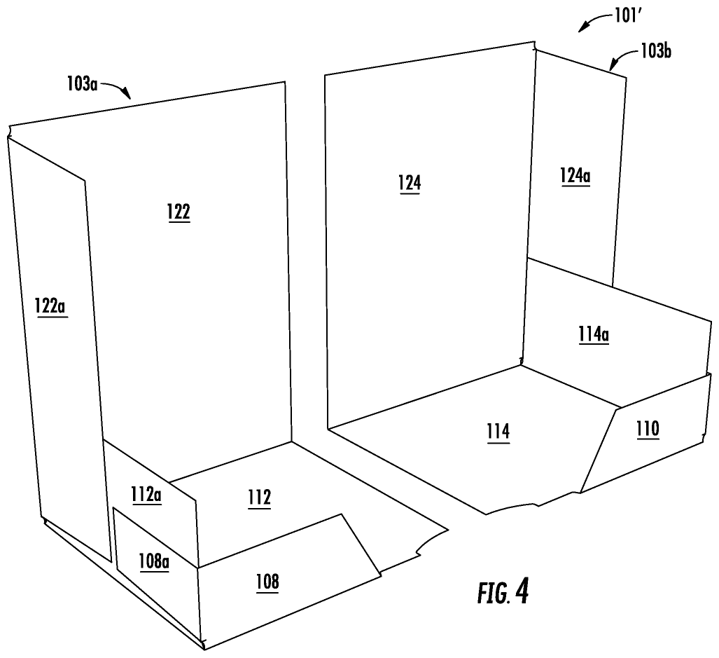

As shown in FIG. 3, the display portion 101′ of the retail ready package 101 is positioned into a display orientation, wherein the left and right lower front panels 108 and 110 are facing forward. The left lower front panel 108, the left bottom panel 112 and the left lower rear panel 122 are adapted and configured to be divided from the right lower front panel 110, the right bottom panel 114 and the right lower rear panel 124 along the bottom vertical line of weakness 118 and the rear vertical line of weakness 128 to form two separate product display cases 103a and 103b, as shown in FIG. 4. Thereupon, as shown in FIG. 4, the two separate product display cases 103a and 103b are retail ready with two rows of products 130a and 130b arranged side-by-side in a vertical front facing display orientation. Rows of product 130a and 130b are not shown in FIG. 4, but would be similarly positioned to those shown in FIG. 3, where row 130a would go with display case 103a and row 130b would go with display case 103b.

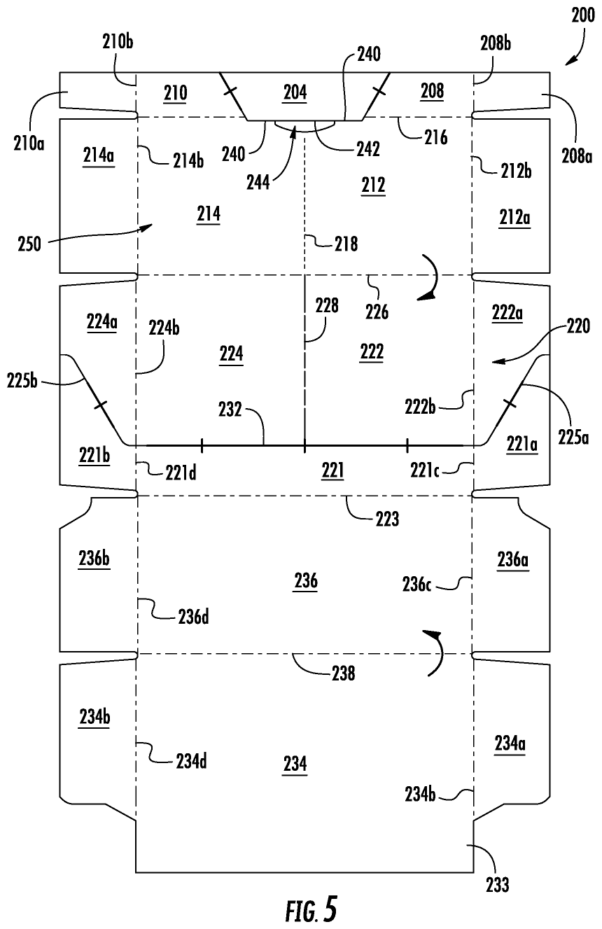

In another embodiment, as shown in FIG. 5, a blank 200 for forming the retail ready package 201 in accordance with the present disclosure, is similar to blank 100 in that blank 200 includes a lower front panel 202. Blank 200, however, includes an upper rear horizontal line of weakness 232 that goes continuously linearly, e.g. straight, across the rear panel 220, instead of along an edge of the rear panel, like upper rear horizontal line of weakness 132. Horizontal line of weakness is substantially parallel to fold line 223 and substantially perpendicular to vertical line of weakness 228, and fold lines 222b, 224b, 221c and 221d. Blank 200 also includes left and right lower rear side flaps 222a and 224a and left and right upper rear side flaps 221a and 221b configured to be separated by respective left and right continuations 225a and 225b of rear horizontal line of weakness 232. Otherwise, blank 200 is substantially similar to blank 100.

With continued reference to FIG. 5, the lower front panel 202 includes a central panel 204 and front lines of weakness 206a and 206b that are the same central panel 104 and lines of weakness 106a and 106b, as such the description provided above for these aspects readily applies herein. The remainder of the lower front panel 202 includes left and right lower front panels 208 and 210. The left and right lower front panels 208 and 210 have respective left and right lower front side flaps 208a and 210a that are foldably connected thereto along respective fold lines 208b and 210b. Blank includes a bottom panel 250 that includes left and right bottom panels 212 and 214 that are respectively foldably connected to the left and right lower front panels 208 and 210 along a lower front horizontal fold line 216 and they are separated from one another along a bottom vertical line of weakness 218. The left and right bottom panels 212 and 214 have respective left and right bottom side flaps 212a and 214a foldably connected thereto along respective vertical fold lines 212b and 214b.

As shown in FIG. 5, rear panel 220 includes an upper rear panel 221 and left and right lower rear panels 222 and 224 respectively. Left and right lower rear panels 222 and 224 foldably connect to the left and right bottom panels 212 and 214 along a lower rear horizontal fold line 226. Left and right lower rear panels 222 and 224 are separated from one another along a rear vertical line of weakness 228. The left and right lower rear panels 222 and 224 have respective left and right lower rear side flaps 222a and 224a foldably connected thereto along respective vertical fold lines 222b and 224b. The upper rear panel 221 is separably connected to the left and right lower rear panels 222 and 224 along a continuous linear rear horizontal line of weakness 232. The rear horizontal line of weakness 232 is a break line, cut lines, or perforation line, any combination thereof, or the like. The upper rear panel 221 has left and right upper rear side flaps 221a and 221b foldably connected thereto along respective fold lines 221c and 221d. The left and right upper rear side flaps 221a and 221b are separated from the left and right lower rear side flaps 222a and 224a by respective left and right continuations 225a and 225b of rear horizontal line of weakness 232.

With continued reference to FIG. 5, the blank 200 also includes a top panel 236 foldably connected to the upper rear panel 221 along an upper rear fold line 223. An upper front panel 234 is foldably connected to the top panel 236 along an upper front horizontal fold line 238. The top panel 236 has left and right top side flaps 236a and 236b foldably connected thereto along respective fold lines 236c and 236d. The upper front panel 234 has left and right upper front side flaps 234a and 234b foldably connected thereto along respective fold lines 234c and 234d, which are the same as left and right upper side flaps 134a and 134d.

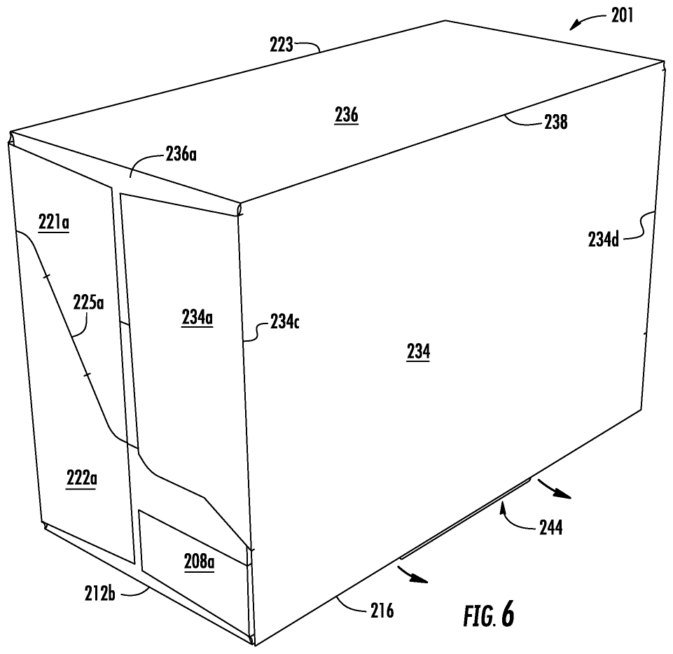

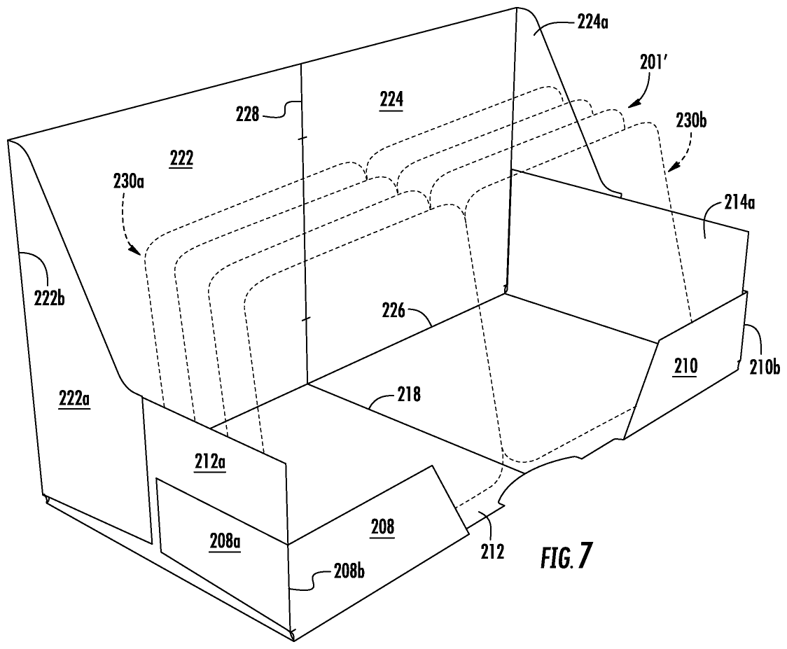

As best seen in FIGS. 6 and 7, the central panel 204, the upper rear panel 221, the top panel 236, the upper front panel 234, and their associated side flaps are adapted and configured to be separated from the remainder of the lower front panel, e.g. left and right lower front panels 208 and 210, the left and right bottom panels 212 and 214 and the left and right lower rear panels 222 and 224 along a rear horizontal line of weakness 232, respective left and right continuations 225a and 225b of rear horizontal line of weakness 232, and the front lines of weakness 206a and 206b. The lower front horizontal fold line 216 includes a cut portion 240 that defines a bottom edge 242 of the central panel 204. An aperture 244 is defined across the left and right bottom panels 212 and 214. An edge of aperture 244 is defined by bottom edge 242 of central panel 204. Aperture 244 is the same as aperture 144, therefore the description provided above for aperture 144 readily applies to aperture 244. The aperture 244 can be grasped by a user to facilitate the severing of the lines of weakness 206a, 206b and 232, and the separation of the removable portion of the package 201 from the display portion 201′ of the package 201, shown schematically by arrows in FIG. 6.

Referring now to FIGS. 5-7, to erect the retail ready package 201 of the subject invention from the die cut blank 200, the left and right bottom panels 212 and 214 are folded along the lower rear horizontal fold line 226, and the upper front panel 234 is folded along the upper front horizontal fold line 238, as shown schematically by the arrows in FIG. 5. An outer surface of the central panel 204 is adhered to an inner surface 233 of the upper front panel 234. At such a time, two rows of products 230a and 230b can be loaded into the partially erected package 201 in side-by-side relationship. Thereafter, to fully erect the retail ready package 201 for shipping, the top panel 236 is folded relative to the upper rear panel 221 along the upper rear fold line 223, and left and right lower front panels 208 and 210 are folded relative to the left and right bottom panels 212 and 214 along the lower front horizontal fold line 216. Then, the side flaps of each of the panels are folded into place and glued, so as to fully form the package 201, as shown in FIG. 6. More particularly, side flaps 236a, 236b, 212a and 214a form interior side flaps of the package, while side flaps 222a, 224a, 221a, 221b, 234a, 234b, 208a and 208b form exterior side flaps of the package 201. It is contemplated that no glue is present between an inner surface of side flap 234a and an outer surface of side flap 212a, such that upper front panel 234 is free to be separated from bottom panels 212 and 214 and lower rear panels 222 and 224.

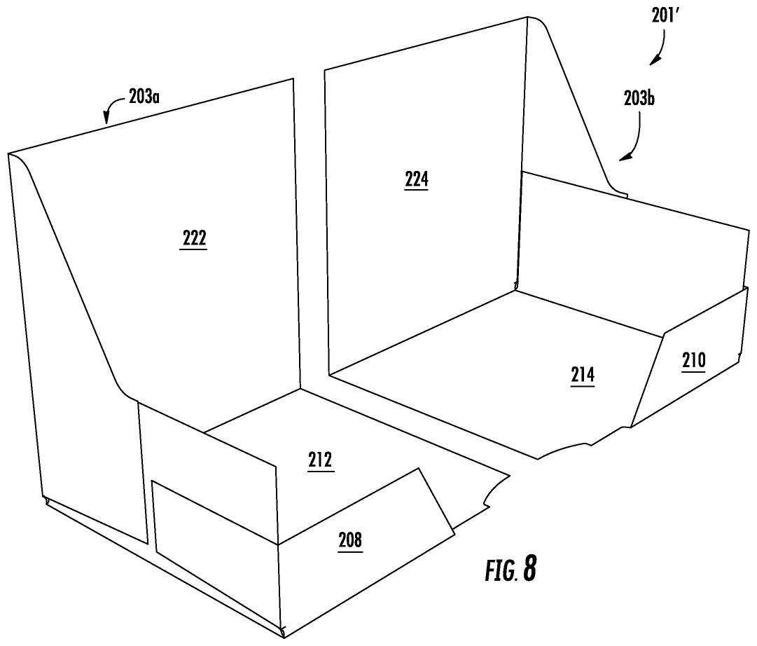

As shown in FIGS. 6-8, to prepare the retail ready package 201 of the subject invention for display, the top panel 236, the upper front panel 234, the upper rear panel 221, the central panel 204, and the side flaps associated therewith are separated from the left and right lower front panels 208 and 210, the left and right bottom panels 212 and 214, and the left and right rear panels 222 and 224 along the upper rear horizontal line of weakness 232, respective left and right continuations 225a and 225b, and front lines of weakness 206a and 206b. The display portion 201′ of the retail ready package 201 is positioned into a display orientation shown in FIG. 7, similar to display portion 101′. The left lower front panel 208, the left bottom panel 212 and the left lower rear panel 222 are adapted and configured to be divided from the right lower front panel 210, the right bottom panel 214 and the right lower rear panel 224 in the same manner as display portion 101′. Rows of product 230a and 230b are not shown in FIG. 8, but would be similarly positioned to those shown in FIG. 7, where row 230a would go with display case 203a and row 230b would go with display case 203b.

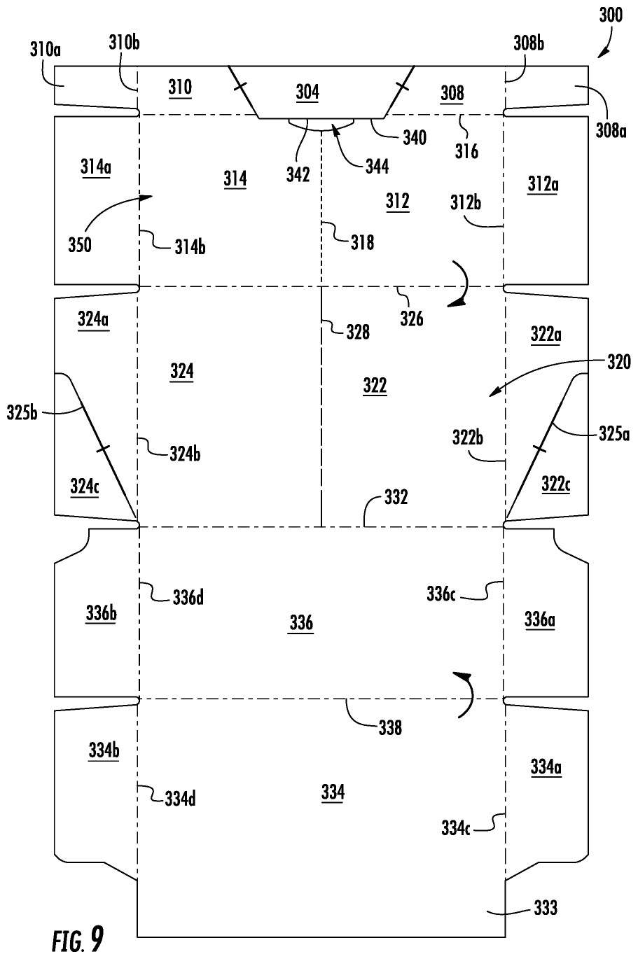

As shown in FIGS. 9-11, a blank 300 for constructing the retail ready package is similar to blank 100. Blank 300 is configured for division into two separate product display cases 303a and 303b. The blank 300 is different from blank 100 in that an upper rear horizontal line of weakness 332 of blank 300 has respective left and right continuations 325a and 325b that extend onto respective side flaps, described in more detail below. Otherwise, blank 300 is the same as blank 100. The blank 300 includes a lower front panel 302 having a central panel 304 and front lines of weakness 306a and 306b, similar to central panel 104 and front lines of weakness 106a and 106b. The remainder of the lower front panel includes left and right lower front panels 308 and 310. The left and right lower front panels 308 and 310 have respective left and right lower front side flaps 308a and 310a that are foldably connected thereto along respective fold lines 308b and 310b.

With continued reference to FIGS. 9-11, blank 300 includes a bottom panel 350 having left and right bottom panels 312 and 314 that are respectively foldably connected to the left and right lower front panels 308 and 310 along a lower front horizontal fold line 316 and they are separated from one another along a bottom vertical line of weakness 318. The front lines of weakness 306a and 306b are the same as those of blank 100. The lower front horizontal fold line 316 includes a cut portion 340 that defines a bottom edge 342 of the central panel 304. An aperture 344 is the same as aperture 144, described above. The left and right bottom panels 312 and 314 have respective left and right bottom side flaps 312a and 314a foldably connected thereto along respective vertical fold lines 312b and 314b. The rear panel 320 includes left and right rear panels 322 and 324 respectively foldably connected to the left and right bottom panels 312 and 314 along a lower rear horizontal fold line 326. Left and right rear panels 322 and 324 are separated from one another along a rear vertical line of weakness 328. The left and right rear panels 322 and 324 have respective left and right rear side flaps 322a and 322c and 324a and 324c foldably connected thereto along respective vertical fold lines 322b and 324b.

As shown in FIGS. 9-11, the blank 300 also includes a top panel 336, upper rear horizontal line of weakness 332, an upper front panel 334, and an upper front horizontal fold line 338, all of which are similar to those included in blank 100, as such the description provided above readily applies to blank 300. The top panel 336 has left and right top side flaps 336a and 336b foldably connected thereto along respective fold lines 336c and 336d. The upper front panel 334 has left and right upper front side flaps 334a and 334b, similar to left and right upper front side flaps 134a and 134b, foldably connected thereto along respective fold lines 334c and 334d. The central panel 304, the top panel 336 and the upper front panel 334 are adapted and configured to be separated from the remainder of the lower front panel, e.g. left and right lower front panels 308 and 310, the left and right bottom panels 312 and 314 and the left and right rear panels 322 and 324 along the upper rear horizontal line of weakness 332 and the front lines of weakness 306a and 306b.

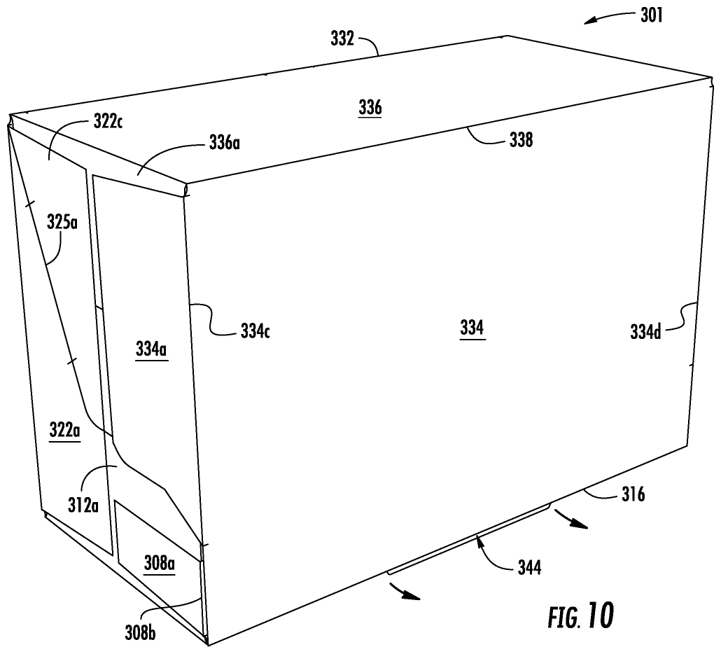

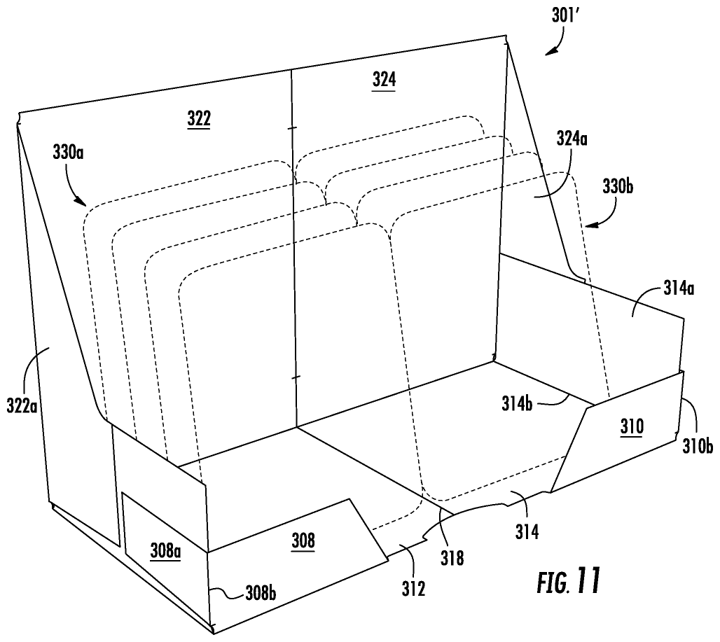

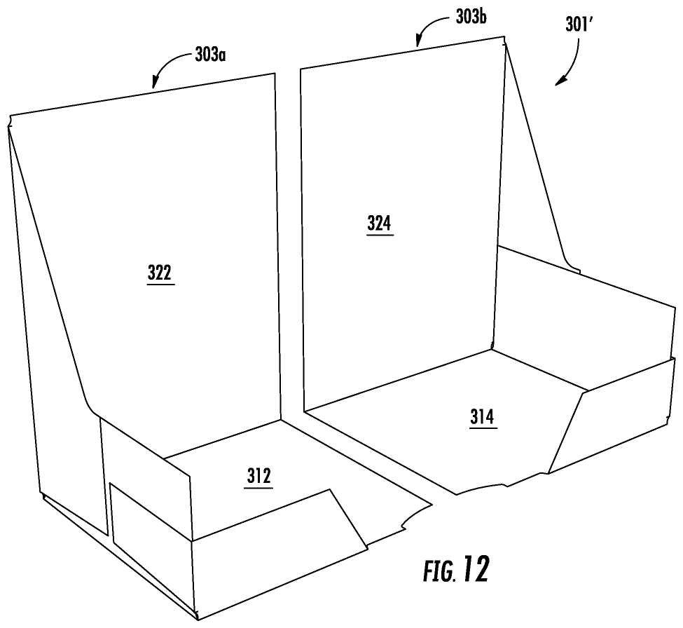

Referring now to FIGS. 10-12, to erect the retail ready package 301 of the subject invention from the die cut blank 300, steps similar to those described above for blank 100 can be used. Except that, to prepare the retail ready package 301 of the subject invention for display, in addition to the top panel 336, the upper front panel 334, the central panel 304, and the side flaps associated therewith, left and right upper rear side flaps 322c and 324c are also removed. Left and right upper rear side flaps 322c and 324c are configured to be separated from lower left and right rear side flaps 322a and 324a by respective left and right continuations 325a and 325b of rear horizontal line of weakness 332. The display portion 301′ of the retail ready package 301 is positioned into a display orientation, e.g. with the fronts of the products 330a and 330b facing outward, and separated into product display cases 303a and 303b, the same way as display portion 101′. Rows of product 330a and 330b are not shown in FIG. 12, but would be similarly positioned to those shown in FIG. 11, where row 330a would go with display case 303a and row 330b would go with display case 303b.

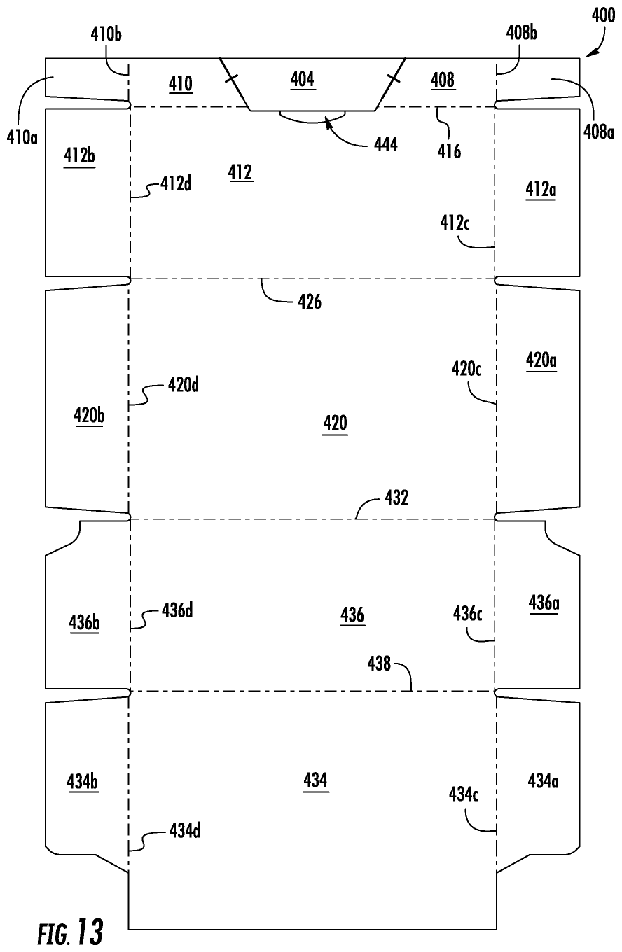

As shown in FIG. 13, a blank 400 for constructing a retail ready package is the same as blank 100 except that blank 400 is not configured for division into two separate product display cases and does not include vertical lines of weakness 118 and 128. The blank 400 includes a lower front panel 402 having a central panel 404 separably connected to a remainder of the lower front panel between front lines of weakness 406a and 406b. The remainder of the lower front panel includes left and right lower front panels 408 and 410. The left and right lower front panels 408 and 410 have respective left and right lower front side flaps 408a and 410a that are foldably connected thereto along respective fold lines 408b and 410b. Bottom panel 412 is foldably connected to the left and right lower front panels 408 and 410 along a lower front horizontal fold line 416. Bottom panel 412 includes left and right side flaps 412a and 412b foldably connected to bottom panel 412 along respective vertical fold lines 412c and 412d.

With continued reference to FIG. 13, the blank 400 also a rear panel 420 foldably connected to bottom panel 412 along a lower rear horizontal fold line 426. Rear panel 420 includes left and right rear side flaps 420a and 420b foldably connected thereto along respective vertical fold lines 420c and 420d. Blank 400 includes a top panel 436 that is separably connected to the rear panel 420 along an upper rear horizontal line of weakness 432. An upper front panel 434 is foldably connected to the top panel 436 along an upper front horizontal fold line 438. Upper front panel 434 includes left and right side flaps 434a and 434b foldably connected thereto along respective vertical fold lines 434c and 434d. An aperture 444 is defined in bottom panel 412 and is similar to aperture 144. front panel 434 can be grasped by a user to facilitate the severing of lines of weakness 406a, 406b and 432, thereby also facilitating separation of the removable portion of the package (e.g. the central panel 404, the upper front panel 434 and associated flaps, and the top panel 436 and associated flaps) from the display portion of the package, similar to the removal described with respect to container 101 in FIGS. 2-3.

The methods and systems of the present disclosure, as described above and shown in the drawings, provide for easy to use and stable retail ready packaging that is shipped with product having advantages over traditional packaging, such as increased strength and ease of use. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A blank for constructing a retail ready package configured to display products, comprising:
a) a lower front panel having a central panel separably connected to a remainder of the lower front panel between front lines of weakness;
b) a bottom panel foldably connected to the lower front panel along a lower front horizontal fold line;
c) a rear panel foldably connected to the bottom panel along a lower rear horizontal fold line;
d) a top panel connected to the rear panel along at least one of an upper rear horizontal line of weakness or an upper rear fold line; and
e) an upper front panel foldably connected to the top panel along an upper front horizontal fold line.

2. A blank as recited in claim 1, wherein the rear panel includes an upper rear panel and a lower rear panel.

3. A blank as recited in claim 2, wherein the central panel, the top panel, the upper front panel and the upper rear panel are adapted and configured to be separated from the remainder of the lower front panel, the bottom panel and the lower rear panel along a rear horizontal line of weakness and the front lines of weakness.

4. A blank as recited in claim 3, wherein the rear horizontal line of weakness is a continuous linear line of weakness.

5. A blank as recited in claim 1, wherein the upper rear horizontal line of weakness is a continuous linear line of weakness.

6. A blank as recited in claim 1, wherein the central panel, the top panel and the upper front panel are adapted and configured to be separated from the remainder of the lower front panel, the bottom panel and the rear panel along the upper rear horizontal line of weakness and the front lines of weakness.

7. A blank as recited in claim 1, wherein the rear panel includes left and right rear panels separated from one another along a rear vertical line of weakness, wherein the bottom panel includes left and right bottom panels separated from one another along a bottom vertical line of weakness, wherein the remainder of the lower front panel includes a left lower front panel and a right lower front panel, wherein the left lower front panel, the left bottom panel and the left rear panel are adapted and configured to be divided from the right lower front panel, the right bottom panel and the right rear panel along the bottom vertical line of weakness and the rear vertical line of weakness to form two separate product display cases.

8. A blank as recited in claim 1, wherein the front lines of weakness are at a non-zero angle relative to the lower front horizontal fold line.

9. A blank as recited in claim 1, further comprising an aperture defined in the bottom panel.

10. A retail ready package configured to display products, comprising:
a) a lower front panel having a central panel separably connected to a remainder of the lower front panel between front lines of weakness;
b) a bottom panel foldably connected to the lower front panel along a lower front horizontal fold line;
c) a rear panel foldably connected to the bottom panel along a lower rear horizontal fold line;
d) a top panel connected to the rear panel along at least one of an upper rear horizontal line of weakness or an upper rear fold line; and
e) an upper front panel foldably connected to the top panel along an upper front horizontal fold line.

11. A retail ready package as recited in claim 10, wherein the rear panel includes an upper rear panel and a lower rear panel.

12. A retail ready package as recited in claim 11, wherein the central panel, the top panel, the upper front panel and the upper rear panel are adapted and configured to be separated from the remainder of the lower front panel, the bottom panel and the lower rear panel along a rear horizontal line of weakness and the front lines of weakness.

13. A retail ready package as recited in claim 12, wherein the rear horizontal line of weakness is a continuous linear line of weakness.

14. A retail ready package as recited in claim 10, wherein the upper rear horizontal line of weakness is a continuous linear line of weakness.

15. A retail ready package as recited in claim 10, wherein the central panel, the top panel and the upper front panel are adapted and configured to be separated from the remainder of the lower front panel, the bottom panel and the rear panel along the upper rear horizontal line of weakness and the front lines of weakness.

16. A retail ready package as recited in claim 10, wherein the rear panel includes left and right rear panels separated from one another along a rear vertical line of weakness, wherein the bottom panel includes left and right bottom panels separated from one another along a bottom vertical line of weakness, wherein the remainder of the lower front panel includes a left lower front panel and a right lower front panel, wherein the left lower front panel, the left bottom panel and the left rear panel are adapted and configured to be divided from the right lower front panel, the right bottom panel and the right rear panel along the bottom vertical line of weakness and the rear vertical line of weakness to form two separate product display cases.

17. A retail ready package as recited in claim 10, wherein the front lines of weakness are at a non-zero angle relative to the lower front horizontal fold line.

18. A retail ready package as recited in claim 10, further comprising an aperture defined in the bottom panel.

19. A retail ready package as recited in claim 10, wherein two rows of products are arranged side-by-side within the package in a vertical front facing display orientation relative to the lower front panel of the package.

20. A retail ready package as recited in claim 10, wherein an outer surface of the central panel is adhered to an inner surface of the upper front panel.
